(19) United States
(12) Patent Application Publication
(10) Pub. No.: US 2026/0104080 A1
(43) Pub. Date: Apr. 16, 2026

(54) MASS DAMPER FOR VIBRATION REDUCTION IN VEHICLE AIR CONDITIONING SYSTEM

(71) Applicant: HS R & A Co., Ltd., Yangsan-si (KR)

(72) Inventors: Jaewon SIM, Yangsan-si (KR); Kwonsik HWANG, Yangsan-si (KR); Jaehyeok CHOI, Yangsan-si (KR); Youngjun KIM, Yangsan-si (KR)

(21) Appl. No.: 19/273,022

(22) Filed: Jul. 17, 2025

(30) Foreign Application Priority Data
Oct. 14, 2024 (KR) 10-2024-0139859

(51) Int. Cl. F16F 7/10; B60H 1/00

(52) U.S. Cl. CPC F16F 7/10; B60H 1/00507; B60H 2001/006; F16F 2222/08; F16F 2230/0005

(57) ABSTRACT

The present invention relates to a mass damper for reducing vibration in a vehicle air conditioning system. The mass damper for reducing vibration in a vehicle air conditioning system according to the embodiments of the present invention is mounted on the refrigerant pipe of the vehicle air conditioning system, and the mass damper for reducing vibration generated in the refrigerant pipe has a predetermined cross-sectional shape, is formed long along the length direction of the refrigerant pipe, and comprises a damper body installed to wrap around the outer circumferential surface of the refrigerant pipe, wherein the damper body is manufactured by considering multiple design factors comprising the cross-sectional shape and the length of the body formed along the length direction of the refrigerant pipe, in order to optimize the weight for reducing vibrations generated in the refrigerant pipe according to the operating conditions of the vehicle air conditioning system.

### CROSS-REFERENCE TO RELATED APPLICATIONS

This application claims priority Republic of Korea Patent Application No. 10-2024-0139859, filed on Oct. 14, 2024, which is incorporated by reference herein in its entirety.

### TECHNICAL FIELD

The present invention relates to a mass damper for reducing vibration in a vehicle air conditioning system, and more specifically, to a mass damper for reducing vibration in a vehicle air conditioning system which can maximize the reduction performance for vibration and noise generated in a refrigerant pipe depending on the operating conditions and status of the vehicle air conditioning system.

### BACKGROUND ART

In general, a vehicle air conditioning system is a system that maintains a comfortable indoor environment by controlling the temperature and humidity inside the vehicle through compression, condensation, expansion, and evaporation of refrigerant, and is constituted of a compressor, condenser, expansion valve, evaporator, and refrigerant pipes connecting them.

In this vehicle air conditioning system, the refrigerant compressed to high temperature and high pressure by the compressor flows at high speed along the refrigerant pipes, causing vibrations in the refrigerant pipes, and this vibration of the refrigerant pipes not only amplifies the noise of the compressor, but also causes the circulating refrigerant to leak from the joints of the refrigerant pipes because of excessive stress concentration.

To address these issues, vibration reduction devices of various structures are being developed for vehicle air conditioning systems to reduce vibrations generated in refrigerant pipes.

For example, various structures of refrigerant pipes are disclosed to improve the vibration insulation performance of refrigerant piping in order to reduce vibration generated in the refrigerant piping, such as in Korean Patent Publication No. 10-2021-0125669 (Air Conditioning Piping System) (Published on Oct. 19, 2021), Korean Patent Registration No. 10-2524318 (Air Conditioning Piping System) (Announced on Apr. 24, 2023), and Korean Patent Registration No. 10-2702884 (Air Conditioning Piping System and Manufacturing Method Thereof) (Announced on Sep. 5, 2024).

However, since conventional vibration reduction devices simply improved the materials of refrigerant pipes, flange members, joint structures, etc. to improve the vibration insulation performance of refrigerant pipes, there was still a problem in that vibrations generated from compressors, etc. were transmitted into the vehicle interior through the refrigerant pipes.

Therefore, a mass damper for reducing vibration in a vehicle air conditioning system is required to maximize the reduction performance for vibration and noise generated in a refrigerant pipe depending on the operating conditions and status of the vehicle air conditioning system.

### SUMMARY

The present invention has been made to improve the above-mentioned problems, and the problem to be solved by the present invention is to provide a mass damper for reducing vibration in a vehicle air conditioning system, which is mounted on a refrigerant pipe of a vehicle air conditioning system and is constituted of a damper body having a predetermined cross-sectional shape and formed long, wherein the damper body is manufactured by considering a plurality of design factors such as the cross-sectional shape and the body length, thereby optimizing the weight and shape of the damper body according to the operating conditions and state of the vehicle air conditioning system and maximizing the reduction performance for vibration and noise generated in the refrigerant pipe.

The technical problems of the present invention are not limited to those mentioned above, and other technical problems not mentioned will be clearly understood by those skilled in the art from the description below.

To achieve the objectives, the mass damper for reducing vibration in a vehicle air conditioning system according to the embodiments of the present invention is mounted on the refrigerant pipe of the vehicle air conditioning system, and the mass damper for reducing vibration generated in the refrigerant pipe has a predetermined cross-sectional shape, is formed long along the length direction of the refrigerant pipe, and comprises a damper body installed to wrap around the outer circumferential surface of the refrigerant pipe, wherein the damper body is manufactured by considering multiple design factors comprising the cross-sectional shape and the length of the body formed along the length direction of the refrigerant pipe in order to optimize the weight for reducing vibrations generated in the refrigerant pipe according to the operating conditions of the vehicle air conditioning system.

As an example, in a mass damper for reducing vibration in a vehicle air conditioning system according to the first embodiments of the present invention, the cross-sectional shape of the damper body is circular, a hollow part into which the refrigerant pipe is inserted and coupled is formed along the longitudinal direction, and the plurality of design factors comprise an outer diameter of the damper body, an inner diameter of the hollow part, and a body length.

As another example, in a mass damper for reducing vibration in a vehicle air conditioning system according to the second embodiments of the present invention, the cross-sectional shape of the damper body is a polygon comprising a plurality of sides, a hollow part into which the refrigerant pipe is inserted and coupled is formed along the longitudinal direction, and the plurality of design factors comprise the number of sides constituting the polygon, the length of each of the plurality of sides constituting the polygon, an angle between two adjacent sides among the plurality of sides constituting the polygon, a fillet radius formed at corners of two adjacent sides among the plurality of sides constituting the polygon, and the body length.

Meanwhile, the mass damper for reducing vibration in a vehicle air conditioning system according to embodiments of the present invention further comprising: a fixing means for fixing the damper body to a predetermined position of the refrigerant pipe, wherein the fixing means comprises a pair of tie straps respectively disposed at the front and rear ends of the damper body along the longitudinal direction of the refrigerant pipe.

At this time, the fixing means further comprising: a flex guard that is installed between the outer circumferential surface of the refrigerant pipe and the inner circumferential surface of the hollow part and is formed long along the length of the refrigerant pipe.

In addition, the damper body, wherein at least one incision part is formed along the longitudinal direction and communicates with the hollow part, and the plurality of design factors further comprising: the number of the incision parts and the incision width of each of the at least one incision part.

In addition, the mass damper for reducing vibration in the vehicle air conditioning system further comprising: a fixing means for fixing the damper body to a predetermined position of the refrigerant pipe, wherein the fixing means comprises a spring clamp installed to wrap around the outer circumferential surface of the damper body.

In addition, the fixing means installed between the outer circumferential surface of the refrigerant pipe and the inner circumferential surface of the hollow part further comprising: a flex guard that is formed long along the length of the refrigerant pipe.

Specific details of other embodiments are included in the detailed description and drawings.

According to a mass damper for reducing vibration in a vehicle air conditioning system according to embodiments of the present invention, the mass damper is mounted on a refrigerant pipe of a vehicle air conditioning system and is constituted of a damper body having a predetermined cross-sectional shape and formed long, wherein the damper body is manufactured by considering a plurality of design factors such as the cross-sectional shape and the body length, thereby optimizing the weight and shape of the damper body according to the operating conditions and state of the vehicle air conditioning system and maximizing the reduction performance for vibration and noise generated in the refrigerant pipe.

As an example, according to a mass damper for reducing vibration in a vehicle air conditioning system according to the first embodiment of the present invention, a damper body may have a circular cross-sectional shape, a hollow part into which a refrigerant pipe is inserted and coupled may be formed, and the damper body may be manufactured by considering a plurality of design factors including an outer diameter of the damper body, an inner diameter of the hollow part, and a body length, thereby optimizing the weight of the damper body having a circular cross-section and maximizing the performance for reducing vibration and noise generated in the refrigerant pipe.

As another example, according to a mass damper for reducing vibration in a vehicle air conditioning system according to the second embodiment of the present invention, a damper body may have a polygonal cross-sectional shape, a hollow part into which a refrigerant pipe is inserted and coupled may be formed, and the damper body may be manufactured by considering a plurality of design factors including the number of sides constituting the polygon, the lengths of each of the plurality of sides, the angle between two adjacent sides, the fillet radius formed at the corners of the two adjacent sides, and the body length, thereby optimizing the weight of the damper body having a circular cross-section and maximizing the performance for reducing vibration and noise generated in the refrigerant pipe.

In addition, according to the mass damper for reducing vibration in the vehicle air conditioning system according to embodiments of the present invention, the damper body may have an incision part formed to communicate with the hollow part along the longitudinal direction, so that the damper body can be easily installed on the outer circumferential surface of the refrigerant pipe.

In addition, according to the mass damper for reducing vibration in the vehicle air conditioning system according to embodiments of the present invention, by installing the damper body on the outer circumferential surface of the refrigerant pipe by a tie strap or a spring clamp depending on the cross-sectional shape of the damper body and whether or not an incision part is formed, not only the damper body can be securely fixed to a predetermined position of the refrigerant pipe, but also the phenomenon of the damper body being deviated from the predetermined position after installation can be prevented.

The effects of the present invention are not limited to the effects mentioned above, and other effects not mentioned will be clearly understood by those skilled in the art from the description of the claims.

### BRIEF DESCRIPTION OF DRAWINGS

FIG. 1 is a diagram illustrating an example that a damper for reducing vibration in a vehicle air conditioning system according to embodiments of the present invention is installed in a refrigerant pipe constituting a vehicle air conditioning system.

FIG. 2 is a perspective view illustrating the structure of a damper body constituting a mass damper for reducing vibration in a vehicle air conditioning system according to the first embodiment of the present invention.

FIG. 3 is a diagram illustrating design factors for a damper body constituting a mass damper for reducing vibration in a vehicle air conditioning system according to the first embodiment of the present invention.

FIG. 4 is a perspective view illustrating the structure of a damper body and a fixing means constituting a mass damper for reducing vibration in a vehicle air conditioning system according to the first embodiment of the present invention.

FIG. 5 is a perspective view illustrating a modified example of a damper body constituting a mass damper for reducing vibration in a vehicle air conditioning system according to the first embodiment of the present invention.

FIG. 6 is a perspective view illustrating the structure of a fixing means for fixing a modified example of a damper body constituting a mass damper for reducing vibration in a vehicle air conditioning system according to the first embodiment of the present invention.

FIG. 7 is a perspective view illustrating the structure of a damper body constituting a mass damper for reducing vibration in a vehicle air conditioning system according to a second embodiment of the present invention.

FIG. 8 is a diagram illustrating design factors for a damper body constituting a mass damper for reducing vibration in a vehicle air conditioning system according to a second embodiment of the present invention.

FIG. 9 is a perspective view illustrating the structure of a damper body and a fixing means constituting a mass damper for reducing vibration in a vehicle air conditioning system according to a second embodiment of the present invention.

FIG. 10 is a perspective view illustrating a modified example of a damper body constituting a mass damper for reducing vibration in a vehicle air conditioning system according to a second embodiment of the present invention.

FIG. 11 is a perspective view illustrating the structure of a damper body and a fixing means constituting a mass damper for reducing vibration in a vehicle air conditioning system according to a second embodiment of the present invention.

### DETAILED DESCRIPTION

Hereinafter, preferred embodiments of the present invention will be described in detail with reference to the attached drawings to enable a person having ordinary skill in the art to easily implement the present invention.

In describing the embodiments, descriptions of technical contents that are well known in the technical field to which the present invention belongs and are not directly related to the present invention will be omitted. This is to convey the gist of the present invention more clearly without obscuring it by omitting unnecessary descriptions.

For the same reason, some components in the attached drawings are exaggerated, omitted, or schematically illustrated. In addition, the size of each component does not entirely reflect the actual size. The same or corresponding components in each drawing are given the same reference numbers.

Additionally, it will be appreciated that expressions and terms used herein with respect to device or element orientation (e.g., “front,” “rear,” “up,” “down,” “top,” “bottom,” “left,” “right,” “lateral,” and the like) are used merely to simplify the description of the invention and do not necessarily indicate or imply that the relevant device or element must have a particular orientation.

Hereinafter, the present invention will be described with reference to drawings for explaining a mass damper for reducing vibration in a vehicle air conditioning system according to embodiments of the present invention.

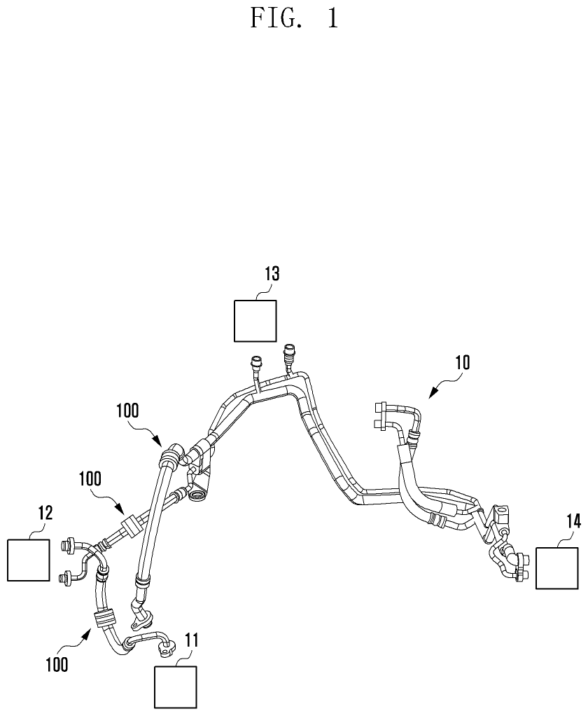

FIG. 1 is a diagram illustrating an example that a damper for reducing vibration in a vehicle air conditioning system according to embodiments of the present invention is installed in a refrigerant pipe constituting a vehicle air conditioning system.

As illustrated in FIG. 1, a vehicle air conditioning system 10 is constituted of a compressor 11, a condenser 12, an expansion valve 13, an evaporator 14, and a refrigerant pipe P connecting them.

Although not illustrated in detail, the gaseous refrigerant is compressed to high temperature and high pressure by the compressor 11 and then liquefied in the condenser 12. The liquefied refrigerant then flows into the evaporator 14 after its pressure is reduced through the expansion valve 13 and evaporates while taking away heat from the surroundings. The evaporated refrigerant is then drawn back into the compressor 11 in a gaseous state.

As illustrated in FIG. 1, a mass damper 100 for reducing vibration in a vehicle air conditioning system 10 according to embodiments of the present invention may be installed at a predetermined position in a refrigerant pipe P connecting a compressor 11, a condenser 12, an expansion valve 13, and an evaporator 14, and can reduce vibration occurring in the refrigerant pipe P.

The mass damper 100 for reducing vibration in a vehicle air conditioning system 10 according to embodiments of the present invention may be configured to include a damper body 110 installed in a refrigerant pipe P and a fixing means 120 for fixing the damper body to the refrigerant pipe P.

At this time, the damper body 110 may be formed long along the length direction of the refrigerant pipe P with a predetermined cross-sectional shape, and may be installed to wrap around the outer circumferential surface of the refrigerant pipe P. Since the vibration reduction performance of this damper body 110 differs depending on the shape and weight, the cross-sectional shape may be determined to adjust the shape, and the vibration reduction performance can be maximized by adjusting the design factors required according to the cross-sectional shape.

Preferably, the damper body 110 may be manufactured by considering a plurality of design factors including a cross-sectional shape and a body length L formed along the longitudinal direction of the refrigerant pipe P to optimize the weight for reducing vibration occurring in the refrigerant pipe P depending on the operating conditions of the vehicle air conditioning system 10.

In this way, according to a mass damper 100 for reducing vibration in a vehicle air conditioning system 10 according to embodiments of the present invention, the mass damper is mounted on a refrigerant pipe P of a vehicle air conditioning system 10 and is constituted of a damper body 110 having a predetermined cross-sectional shape and formed long, wherein the damper body 110 is manufactured by considering a plurality of design factors such as the cross-sectional shape and the body length L, thereby optimizing the weight and shape of the damper body 110 according to the operating conditions and state of the vehicle air conditioning system 10 and maximizing the reduction performance for vibration and noise generated in the refrigerant pipe P.

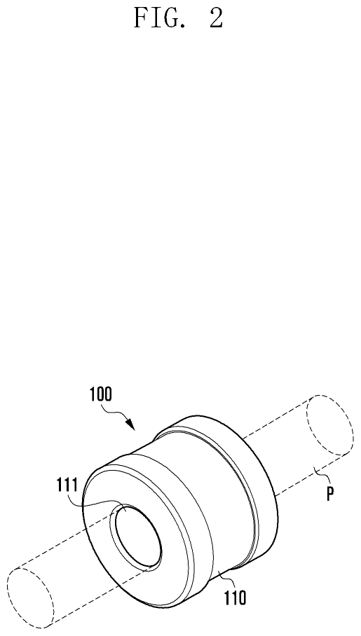

The detailed structures of the damper body 110 and the fixing means 120 constituting such a mass damper will be described in detail for each embodiment with reference to FIGS. 2 to 10.

Meanwhile, FIG. 1 illustrates an example in which three mass dampers 100 are installed in a refrigerant pipe P connecting a compressor 11 and a condenser 12, but is not limited thereto, and the number of mass dampers 100, installation locations, etc. may be changed at any time by a person skilled in the art according to the operating conditions and status of the vehicle air conditioning system 10.

Hereinafter, with reference to FIGS. 2 to 6, the structure of a mass damper 100 for reducing vibration in a vehicle air conditioning system 10 according to the first embodiment of the present invention will be described in detail.

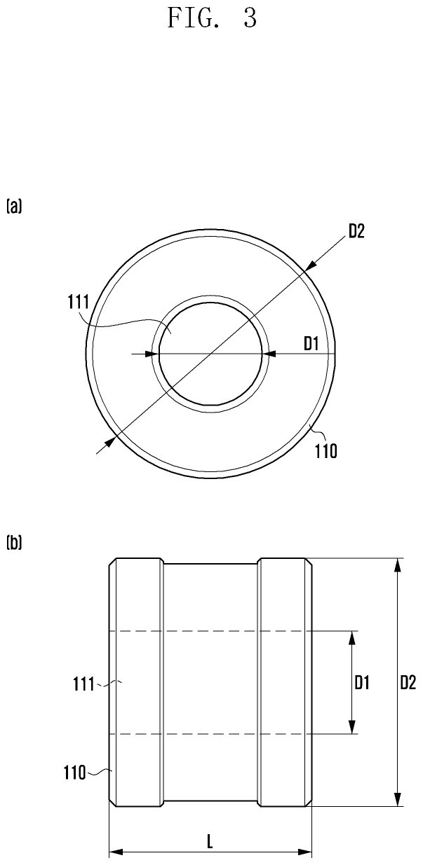

FIG. 2 is a perspective view illustrating the structure of a damper body constituting a mass damper for reducing vibration in a vehicle air conditioning system according to the first embodiment of the present invention, and FIG. 3 is a diagram illustrating design factors for a damper body constituting a mass damper for reducing vibration in a vehicle air conditioning system according to the first embodiment of the present invention.

As illustrated in FIG. 2, a damper body 110 constituting a mass damper 100 for reducing vibration in a vehicle air conditioning system 10 according to the first embodiment of the present invention may be formed to have a circular cross-sectional shape and be formed long, and a hollow part 111 into which a refrigerant pipe P is inserted and coupled along the longitudinal direction to wrap around an outer circumferential surface of the refrigerant pipe P may be formed.

Preferably, as illustrated in FIG. 3, a plurality of design factors for optimizing the weight of the damper body 110 may include an inner diameter D1 of the damper body 110 (i.e., an inner diameter D1 of the hollow part 111), an outer diameter D2 of the damper body 110, and a body length L.

That is, the damper body 110 having a circular cross-sectional shape may be manufactured by considering the inner diameter D1 of the hollow part 111, the outer diameter D2 of the damper body 110, and the body length L in order to optimize the weight for reducing vibration occurring in the refrigerant pipe P depending on the operating conditions of the vehicle air conditioning system 10.

Meanwhile, the fixing means 120 constituting the mass damper 100 for reducing vibration in the vehicle air conditioning system 10 according to the first embodiment of the present invention can fix the damper body 110 to a predetermined position of the refrigerant pipe P.

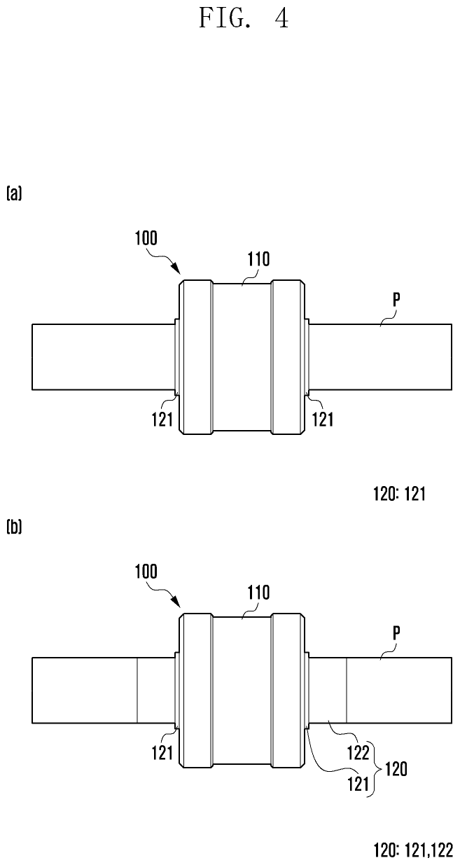

FIG. 4 is a perspective view illustrating the structure of a damper body and a fixing means constituting a mass damper for reducing vibration in a vehicle air conditioning system according to the first embodiment of the present invention.

(a) of FIG. 4 illustrates an example in which the fixing means 120 is constituted of a pair of tie straps 121, and (b) of FIG. 4 illustrates an example in which the fixing means 120 is constituted of a pair of tie straps 121 and a flex guard 122.

First, as illustrated in (a) of FIG. 4, a pair of tie straps 121 may be disposed at the front and rear ends of the damper body 110 along the longitudinal direction of the refrigerant pipe P, respectively. Accordingly, the pair of tie straps 121 can securely fix the damper body 110 to a predetermined position of the refrigerant pipe P, and prevent the damper body 110 from moving along the longitudinal direction of the refrigerant pipe P and being deviated from the predetermined position after installation of the damper body 110.

In addition, as illustrated in (b) of FIG. 4, a flex guard 122 may be installed between the outer circumferential surface of the refrigerant pipe P and the inner circumferential surface of the hollow part 111, and may be formed to be long along the longitudinal direction of the refrigerant pipe P. This flex guard 122 may be installed on the outer circumferential surface of the refrigerant pipe P together with a pair of tie straps 121, and can prevent the damper body 110 from slipping along the longitudinal direction of the refrigerant pipe P. That is, the flex guard 122 may be installed between the outer circumferential surface of the refrigerant pipe P and the inner circumferential surface of the hollow part 111, and in a state where the damper body 110 is installed on the outer circumferential surface of the flex guard 122, the damper body 110 can be securely fixed to a predetermined position of the refrigerant pipe P by a pair of tie straps 121 at the front and rear ends of the damper body 110.

Meanwhile, in FIGS. 2 to 4, examples are illustrated in which the damper body 110 is formed as an integral body, but considering the installation work on the refrigerant pipe P, the damper body 110 may be formed as a separate body.

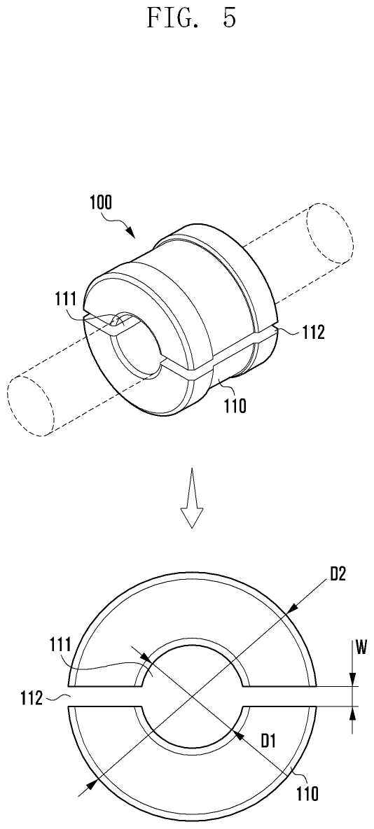

FIG. 5 is a perspective view illustrating a modified example of a damper body constituting a mass damper for reducing vibration in a vehicle air conditioning system according to the first embodiment of the present invention.

As illustrated in FIG. 5, the damper body 110 may be formed with at least one incision part 112 communicating with the hollow part 111 along the longitudinal direction. For example, FIG. 5 illustrates an example in which a pair of incision parts 112 are formed at a position intersecting the center of the hollow part 111 formed in the damper body 110 (i.e., the axial center of the refrigerant pipe P).

In this case, the damper body 110 may be constituted of a pair of bodies separated vertically around the refrigerant pipe P, and the upper and lower bodies may be joined to the outer circumferential surface of the refrigerant pipe P while facing each other. In this way, when the incision part 112 is formed in the damper body 110, the damper body 110 may have a separate structure, which has the advantage of being easily installed on the outer circumferential surface of the refrigerant pipe P.

Preferably, in the modified example illustrated in FIG. 5, the plurality of design factors for optimizing the weight of the damper body 110 may further include the number of incision parts 112 and the incision width W of each of at least one incision part 112.

That is, the damper body 110 having a circular cross-sectional shape and having an incision part 112 formed therein may be manufactured by considering the outer diameter D2 of the damper body 110, the inner diameter D1 of the hollow part 111, the body length L, the number of incision parts 112, and the incision width W of each incision part 112 in order to optimize the weight for reducing vibration occurring in a refrigerant pipe P depending on the operating conditions of the vehicle air conditioning system 10.

Meanwhile, FIG. 5 illustrates an example in which a pair of incision parts 112 are formed at positions intersecting the center of a hollow part 111 formed in a damper body 110, but is not limited thereto, and the number of incision parts 112, formation positions, etc. may be changed at any time by those skilled in the art.

Meanwhile, as illustrated in FIG. 5, when the damper body 110 is formed with an incision part 112, the fixing means 120 for fixing the damper body 110 to the refrigerant pipe P needs to be implemented differently from the fixing means 120 illustrated in FIG. 4.

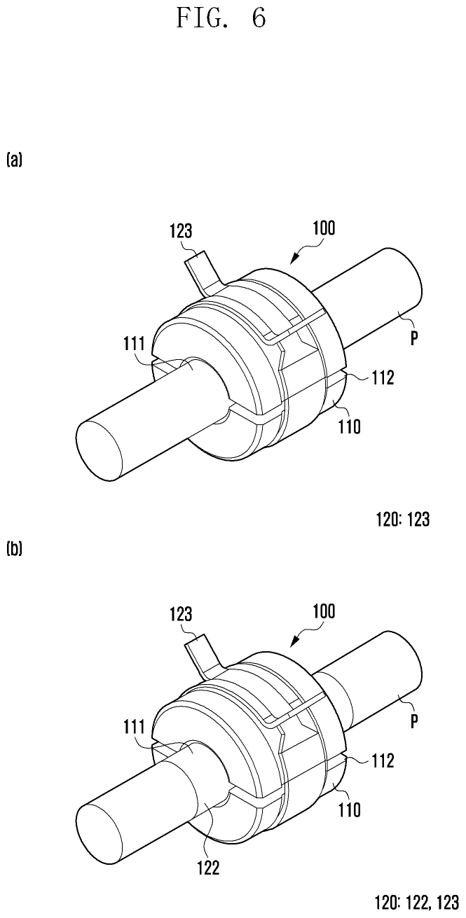

FIG. 6 is a perspective view illustrating the structure of a fixing means for fixing a modified example of a damper body constituting a mass damper for reducing vibration in a vehicle air conditioning system according to the first embodiment of the present invention.

(a) of FIG. 6 illustrates an example in which the fixing means 120 is constituted of a spring clamp 123, and (b) of FIG. 6 illustrates an example in which the fixing means 120 is constituted of a spring clamp 123 and a flex guard 122.

First, as illustrated in (a) of FIG. 6, the spring clamp 123 may be installed to wrap around the outer circumferential surface of the damper body 110. Accordingly, the spring clamp 123 may securely fix the damper body 110 to a predetermined position of the refrigerant pipe P in a state where the hollow part 111 of the detachable damper body 110 in which the incision part 112 is installed is in close contact with the outer circumferential surface of the refrigerant pipe P, and prevent the damper body 110 from moving along the length direction of the refrigerant pipe P and being deviated from the predetermined position after the damper body 110 is installed.

In addition, as illustrated in (b) of FIG. 6, a flex guard 122 may be installed between the outer circumferential surface of the refrigerant pipe P and the inner circumferential surface of the hollow part 111, and in a state where a detachable damper body 110 is in close contact with the outer circumferential surface of the flex guard 122, a spring clamp 123 may be installed to wrap around the outer circumferential surface of the damper body 110, thereby securely fixing the damper body 110 to a predetermined position of the refrigerant pipe P.

In this way, according to the mass damper 100 for reducing vibration in the vehicle air conditioning system 10 according to the first embodiment of the present invention, the damper body 110 may have a circular cross-sectional shape, a hollow part 111 into which a refrigerant pipe P is inserted and coupled may be formed, and the damper body 110 may be manufactured by considering a plurality of design factors including an outer diameter D2 of the damper body 110, an inner diameter D1 of the hollow part 111, and a body length L, thereby optimizing the weight of the damper body 110 having a circular cross-section and maximizing the reduction performance for vibration and noise generated from the refrigerant pipe P.

In addition, according to the mass damper 100 for reducing vibration in the vehicle air conditioning system 10 according to the first embodiment of the present invention, the damper body 110 may have an incision part 112 formed to communicate with the hollow part 111 along the longitudinal direction, so that the damper body 110 can be easily installed on the outer circumferential surface of the refrigerant pipe P.

In addition, according to the mass damper 100 for reducing vibration in the vehicle air conditioning system 10 according to the first embodiment of the present invention, by installing the damper body 110 on the outer circumferential surface of the refrigerant pipe P by a tie strap 121 or a spring clamp 123 depending on the cross-sectional shape of the damper body 110 and whether or not the incision part 112 is formed, not only the damper body 110 can be securely fixed to a predetermined position of the refrigerant pipe P, but also the phenomenon of the damper body 110 being deviated from the predetermined position after installation can be prevented.

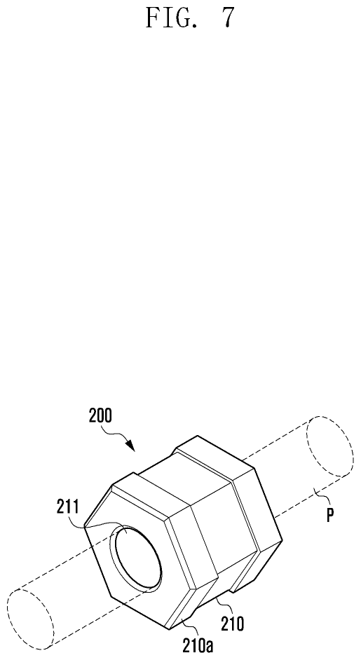

Hereinafter, with reference to FIGS. 7 to 10, the structure of a mass damper 200 for reducing vibration in a vehicle air conditioning system 10 according to a second embodiment of the present invention will be described in detail. For convenience of explanation, the description of the same structure as that of the first embodiment illustrated in FIGS. 2 to 6 will be omitted, and only the differences will be described below.

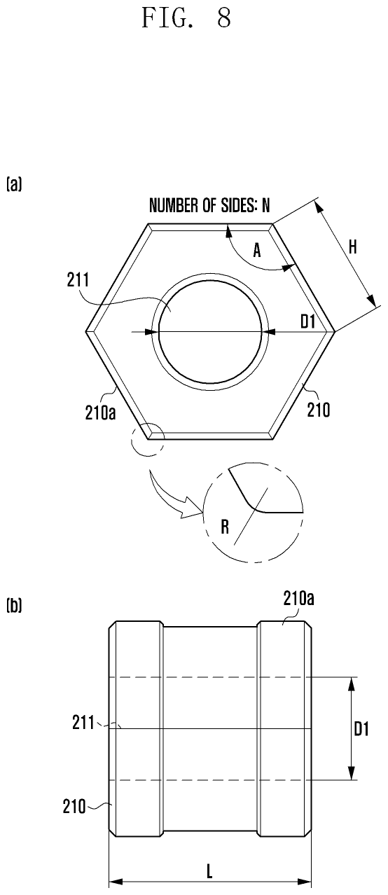

FIG. 7 is a perspective view illustrating the structure of a damper body constituting a mass damper for reducing vibration in a vehicle air conditioning system according to a second embodiment of the present invention, and FIG. 8 is a diagram illustrating design factors for a damper body constituting a mass damper for reducing vibration in a vehicle air conditioning system according to a second embodiment of the present invention.

As illustrated in FIG. 7, the damper body 210 constituting the mass damper 200 for reducing vibration in the vehicle air conditioning system 10 according to the second embodiment of the present invention is different from the first embodiment illustrated in FIGS. 2 to 6 in that its cross-sectional shape is polygonal rather than circular.

That is, the damper body 210 may be formed long with a polygonal cross-sectional shape including a plurality of sides 210a, and a hollow part 211 may be formed along the longitudinal direction into which the refrigerant pipe P is inserted and coupled to wrap around the outer circumferential surface of the refrigerant pipe P. FIG. 8 illustrates an example in which the cross-sectional shape of the damper body 210 is a regular hexagon constituted of six sides having the same length.

Preferably, as illustrated in FIG. 8, a plurality of design factors for optimizing the weight of the damper body 210 may include the number N of sides 210a constituting the polygon, the length H of each of the plurality of sides 210a constituting the polygon, the angle A between two adjacent sides 210a among the plurality of sides 210a constituting the polygon, the fillet radius R formed at the corners of two adjacent sides 210a among the plurality of sides 210a constituting the polygon, and the body length L.

That is, the damper body 210 having a polygonal cross-sectional shape may be manufactured by considering the number N of sides 210a constituting the polygon, the length H of each of the plurality of sides 210a constituting the polygon, the angle A between two adjacent sides 210a among the plurality of sides 210a constituting the polygon, the fillet radius R formed at the corners of two adjacent sides 210a among the plurality of sides 210a constituting the polygon, and the body length L in order to optimize the weight for reducing vibrations generated in the refrigerant pipe P depending on the operating conditions of the vehicle air conditioning system 10.

Meanwhile, FIG. 8 illustrates an example in which the cross-sectional shape of the damper body 210 is a regular hexagon constituted of six sides having the same length, but is not limited thereto, and the number of sides constituting the polygon, the length of the sides constituting the polygon, etc. may be changed at any time by those skilled in the art.

Meanwhile, the fixing means 220 constituting the mass damper 200 for reducing vibration in the vehicle air conditioning system 10 according to the second embodiment of the present invention can fix the damper body 210 to a predetermined position of the refrigerant pipe P.

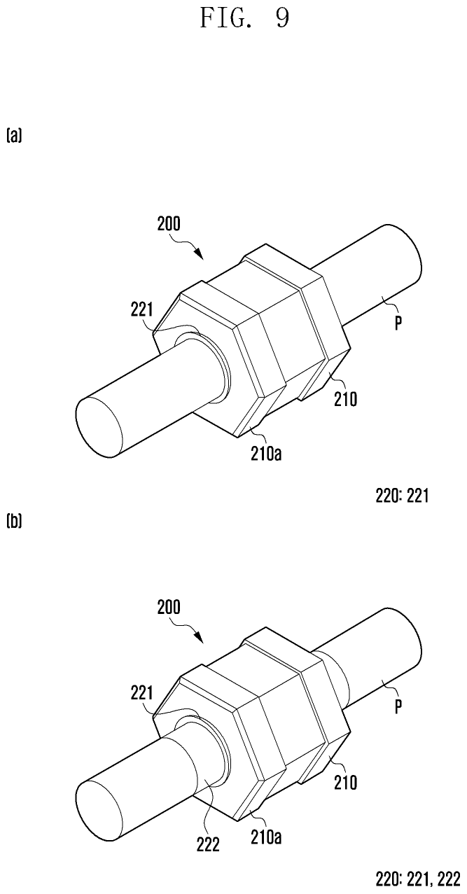

FIG. 9 is a perspective view illustrating the structure of a damper body and a fixing means constituting a mass damper for reducing vibration in a vehicle air conditioning system according to a second embodiment of the present invention.

(a) of FIG. 9 illustrates an example in which the fixing means 220 is constituted of a pair of tie straps 221, and (b) of FIG. 4 illustrates an example in which the fixing means 220 is constituted of a pair of tie straps 221 and a flex guard 222. The structure of the fixing means 220 illustrated in (a) and (b) of FIG. 9 is substantially the same as the structure illustrated in (a) and (b) of FIG. 4, so a duplicate description is omitted.

Meanwhile, in the case of the mass damper 200 for reducing vibration in the vehicle air conditioning system 10 according to the second embodiment of the present invention, the damper body 210 may be formed with an incision part 212 to be manufactured as a separate type. In addition, the fixing means 220 for fixing the damper body 210 with the formed incision part 212 to the refrigerant pipe P may include a spring clamp 223.

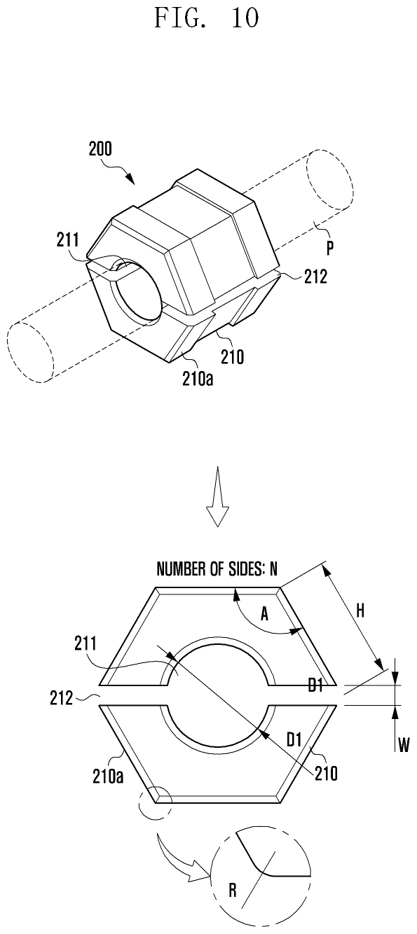

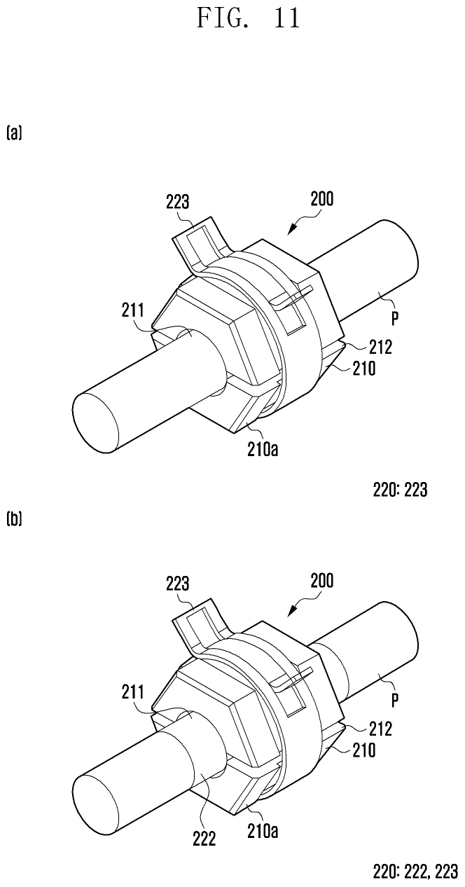

FIG. 10 is a perspective view illustrating a modified example of a damper body constituting a mass damper for reducing vibration in a vehicle air conditioning system according to a second embodiment of the present invention, and FIG. 11 is a perspective view illustrating the structure of a damper body and a fixing means constituting a mass damper for reducing vibration in a vehicle air conditioning system according to a second embodiment of the present invention.

As illustrated in FIG. 10, the damper body 210 may be formed with at least one incision part 212 communicating with the hollow part 211 along the longitudinal direction. FIG. 10 illustrates an example in which a pair of incision parts 212 are formed at a position intersecting the center of the hollow part 211 formed in the damper body 210.

In this way, the damper body 210 having a polygonal cross-sectional shape and having an incision part 212 formed therein may be manufactured by considering the number N of sides 210a constituting the polygon, the length H of each of the sides 210a, the angle A between two adjacent sides 210a among the sides 210a, the fillet radius R formed at the corners of the two adjacent sides 210a among the sides 210a, the body length L, the number of incision parts 212, and the incision width W of each of the incision parts 212 in order to optimize the weight for reducing vibrations occurring in the refrigerant pipe P depending on the operating conditions of the vehicle air conditioning system 10.

Meanwhile, (a) of FIG. 11 illustrates an example in which the fixing means 220 is constituted of only a spring clamp 223, and (b) of FIG. 11 illustrates an example in which the fixing means 220 is constituted of a spring clamp 223 and a flex guard 222. The structure of the fixing means 220 illustrated in (a) and (b) of FIG. 11 is substantially the same as the structure illustrated in (a) and (b) of FIG. 6, so a duplicate description is omitted.

In this way, according to the mass damper 200 for reducing vibration in the vehicle air conditioning system 10 according to the second embodiment of the present invention, the damper body 210 may have a polygonal cross-sectional shape, a hollow part 211 into which a refrigerant pipe P is inserted and coupled may be formed, and the damper body 210 may be manufactured by considering a plurality of design factors including the number N of sides 210a constituting the polygon, the length H of each of the plurality of sides 210a, the angle A between two adjacent sides 210a, the fillet radius R formed at the corners of the two adjacent sides 210a, and the body length L, thereby optimizing the weight of the damper body 210 having a circular cross-section and maximizing the reduction performance for vibration and noise generated from the refrigerant pipe P.

In addition, according to the mass damper 200 for reducing vibration in the vehicle air conditioning system 10 according to the second embodiment of the present invention, the damper body 210 may have an incision part 212 formed to communicate with the hollow part 211 along the longitudinal direction, so that the damper body 210 can be easily installed on the outer circumferential surface of the refrigerant pipe P.

In addition, according to the mass damper 200 for reducing vibration in the vehicle air conditioning system 10 according to the second embodiment of the present invention, by installing the damper body 210 on the outer circumferential surface of the refrigerant pipe P by a tie strap 221 or a spring clamp 223 depending on the cross-sectional shape of the damper body 210 and whether or not the incision part 212 is formed, not only the damper body 210 can be securely fixed to a predetermined position of the refrigerant pipe P, but also the phenomenon of the damper body 210 being deviated from the predetermined position after installation can be prevented.

Meanwhile, the present specification and drawings have disclosed preferred embodiments of the present invention, and although specific terms have been used, they have been used only in a general sense to easily explain the technical contents of the present invention and to help understand the invention, and are not intended to limit the scope of the present invention. It will be apparent to those skilled in the art that other modified examples based on the technical idea of the present invention may be implemented in addition to the embodiments disclosed herein.

### EXPLANATION OF REFERENCE NUMERALS

| | |
|---|---|
| 10: Vehicle air conditioning system | |
| 11: Compressor | 12: Condenser |
| 13: Expansion valve | 14: Evaporator |
| P: Refrigerant pipe | |
| 100: Damper for reducing vibration in vehicle | |
| air conditioning system (first embodiment) | |
| 110: Damper body | 111: Hollow part |
| 112: Incision part | 120: Fixing means |
| 121: Tie strap | 122: Flex guard |
| 123: Spring clamp | |
| 200: Mass damper for reducing vibration in | |
| vehicle air conditioning system (second | |
| embodiment) | |
| 210: Damper body | 210a: Side |
| 211: Hollow part | 212: Incision part |
| 220: Fixing means | 221: Tie strap |
| 222: Flex guard | 223: Spring clamp |

What is claimed is:

1. A mass damper for reducing vibration in a vehicle air conditioning system, which is mounted on a refrigerant pipe of a vehicle air conditioning system and reduces vibration generated in the refrigerant pipe, comprising a damper body that is formed long along a length of the refrigerant pipe with a predetermined cross-sectional shape and is installed to wrap around an outer circumferential surface of the refrigerant pipe,
wherein the damper body is manufactured by considering a plurality of design factors comprising the cross-sectional shape and the body length formed along a longitudinal direction of the refrigerant pipe to optimize a weight for reducing vibration generated in the refrigerant pipe according to operating conditions of the vehicle air conditioning system.

2. The mass damper for reducing vibration in a vehicle air conditioning system of claim 1, wherein the cross-sectional shape of the damper body is circular, a hollow part into which the refrigerant pipe is inserted and coupled is formed along the longitudinal direction, and
wherein the plurality of design factors comprise an outer diameter of the damper body, an inner diameter of the hollow part, and a body length.

3. The mass damper for reducing vibration in a vehicle air conditioning system of claim 2, wherein the cross-sectional shape of the damper body is a polygon comprising a plurality of sides, a hollow part into which the refrigerant pipe is inserted and coupled is formed along the longitudinal direction, and
wherein the plurality of design factors comprise a number of sides constituting the polygon, the length of each of the plurality of sides constituting the polygon, an angle between two adjacent sides among the plurality of sides constituting the polygon, a fillet radius formed at corners of two adjacent sides among the plurality of sides constituting the polygon, and the body length.

4. The mass damper for reducing vibration in a vehicle air conditioning system of claim 2 or claim 3, wherein the damper for reducing vibration in a vehicle air conditioning system further comprises a fixing means for fixing the damper body to a predetermined position in the refrigerant pipe, and
wherein the fixing means comprises a pair of tie straps respectively disposed at front and rear ends of the damper body along the longitudinal direction of the refrigerant pipe.

5. The mass damper for reducing vibration in a vehicle air conditioning system of claim 4, wherein the fixing means further comprises a flex guard that is installed between the outer circumferential surface of the refrigerant pipe and an inner circumferential surface of the hollow part and is formed long along the length of the refrigerant pipe.

6. The mass damper for reducing vibration in a vehicle air conditioning system of claim 2 or claim 3, wherein at least one incision part of the damper body is formed along the longitudinal direction and communicates with the hollow part, and
wherein the plurality of design factors further comprise a number of the incision parts and an incision width of each of the at least one incision part.

7. The mass damper for reducing vibration in a vehicle air conditioning system of claim 6, wherein the damper for reducing vibration in the vehicle air conditioning system further comprises a fixing means for fixing the damper body to a predetermined position in the refrigerant pipe, and
wherein the fixing means comprises a spring clamp installed to wrap around the outer circumferential surface of the damper body.

8. The mass damper for reducing vibration in a vehicle air conditioning system of claim 7, wherein the fixing means comprises a flex guard that is installed between the outer circumferential surface of the refrigerant pipe and an inner circumferential surface of the hollow part and is formed long along the length of the refrigerant pipe.
